(19) United States
(12) Patent Application Publication
(10) Pub. No.: US 2023/0189809 A1
(43) Pub. Date: Jun. 22, 2023

(54) METHODS AND COMPOSITIONS

(71) Applicant: Aaron TINDALL, Bondi Beach (AU)

(72) Inventor: Aaron TINDALL, Bondi Beach (AU)

(21) Appl. No.: 18/000,251

(22) PCT Filed: Jun. 4, 2021
(86) PCT No.: PCT/IB2021/054892

§ 371 Date: Nov. 29, 2022

(30) Foreign Application Priority Data
Jun. 4, 2020 (NZ) 765147

(51) Int. Cl. A01N 43/80; A01N 25/02; A01N 31/02; A01N 55/00

(52) U.S. Cl. CPC A01N 43/80; A01N 25/02; A01N 31/02; A01N 55/00

(57) ABSTRACT

The invention relates to a herbicidal composition comprising saccharin and a penetrant in a liquid carrier. The herbicidal composition can be used to eliminate or reduce undesired plant growth.

### 1. TECHNICAL FIELD

This disclosure relates to eliminating or reducing undesired plant growth.

### 2. BACKGROUND

The ability to eliminate or reduce undesired plant growth is key to modern agricultural practices. For example, killing of weeds or other plants that compete with crop or ornamental plants allows for the stronger growth of the desired plant over the undesired plant.

Resistance to existing herbicides is also an increasing problem. This is particularly a problem because most existing herbicides use one of only a limited number of modes of action. Resistance often develops to a mode of action rather than a specific herbicide.

There is also increasing demand for agricultural practices which are considered organic or at least have reduced toxicity and/or residues to existing herbicides. Poisonous residues from agri-chemicals in all sections of the environment have permeated the food chain and are threatening the future of the world's ecosystem. Roundup (glyphosate), the most widely used agricultural and industrial weed killer, is now under intense scrutiny as to whether or not it causes cancer.

The use of more environmentally friendly methods of plant growth control is particularly an area of demand for high value crops, such as grapes for wine making.

There are other agricultural practices where the undesired growth may be on the desired plant but in an undesired location or with undesired timing. For example, desuckering is the practice of removing young, non-fruit-bearing shoots from a vine to encourage the older stems of the vine to fruit. This type of removal of unwanted growth requires specificity in order to remove the correct portion of the plant without damage to the remaining plant and can therefore be labour intensive and time consuming. A further example of undesired timing of growth is where foliage destroying sprays are used to assist the synchronous maturation of the crop. For example, diquat is in widespread use to “dry off” or “desiccate” the growing portion of a crop leaving the edible part at the same level of maturity. For example, potato haulms are sprayed with diquat, which kills the leaves, leaving the tubers underground ready for harvest.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

### 3. SUMMARY OF THE INVENTION

It is an object of this disclosure to provide a method of eliminating or reducing undesired plant growth and/or a plant growth killing or reducing composition which goes at least some way towards overcoming one or more of the abovementioned problems or difficulties, or to at least provide the industry/public with a useful choice.

In a first aspect there is provided a method of eliminating or reducing undesired plant growth, the method comprising:
applying a liquid composition comprising at least one artificial sweetener or sugar alcohol or an agriculturally acceptable salt thereof and a penetrant to the undesired plant growth.

In some embodiments the liquid composition is applied to the undesired plant growth by contacting, wetting, dousing, drenching, soaking, dipping, painting or spraying.

In some embodiments the liquid composition is sprayed onto the undesired plant growth.

In some embodiments the application of the liquid composition is repeated one or more times. In some embodiments the application is repeated within about 1 month of a first application.

In some embodiments the undesired plant growth is suckers which are part of a desired plant. In some embodiments the undesired plant growth are shoots from a desired bulb or tuber.

In a second aspect there is provided a composition for eliminating or reducing undesired plant growth comprising:
a liquid carrier,
at least one artificial sweetener or sugar alcohol or an agriculturally acceptable salt thereof, and
a penetrant.

In a third aspect there is provided an herbicidal composition comprising
a liquid carrier,
at least one artificial sweetener or sugar alcohol or an agriculturally acceptable salt thereof, and
a penetrant.

In a fourth aspect there is provided a method of making the composition of the second or third aspects comprising adding at least one artificial sweetener or sugar alcohol or an agriculturally acceptable salt thereof, and a penetrant to a liquid carrier.

In the above aspects:

In some embodiments the artificial sweetener or an agriculturally acceptable salt thereof is saccharine, aspartame, sucralose, acesulfame K, stevia or Lugduname.

In some embodiments the sugar alcohol or an agriculturally acceptable salt thereof is xylitol, sorbitol or erythritol.

In some embodiments the artificial sweetener or sugar alcohol or an agriculturally acceptable salt thereof is saccharine.

In some embodiments the concentration of artificial sweetener or sugar alcohol or an agriculturally acceptable salt thereof in the liquid composition is about 5-600 g per litre. In some embodiments the concentration of artificial sweetener or sugar alcohol or an agriculturally acceptable salt thereof in the liquid composition is about 5-400 g per litre. In some embodiments the concentration of artificial sweetener or sugar alcohol or an agriculturally acceptable salt thereof is about 5-300 g per litre. In some embodiments the concentration of artificial sweetener or sugar alcohol or an agriculturally acceptable salt thereof in the liquid composition is about 10-200 g per litre. In some embodiments the concentration of artificial sweetener or sugar alcohol or an agriculturally acceptable salt thereof in the liquid composition is about 50-200 g per litre.

In some embodiments the artificial sweetener or an agriculturally acceptable salt thereof is saccharine salt.

In some embodiments the artificial sweetener or an agriculturally acceptable salt thereof is saccharine sodium.

In some embodiments the concentration of saccharine salt in the liquid composition is about 5-600 g per litre. In some embodiments the concentration of saccharine salt in the liquid composition is about 5-300 g per litre. In some embodiments the concentration of saccharine salt in the liquid composition is about 10-300 g per litre. In some embodiments the concentration of saccharine salt in the liquid composition is about 10-200 g per litre. In some embodiments the concentration of saccharine salt in the liquid composition is about 50-200 g per litre.

In some embodiments the concentration of penetrant in the composition is about 0.5-20 ml/L. In some embodiments the concentration of penetrant in the composition is about 0.5-15 ml/L. In some embodiments the concentration of penetrant in the composition is about 0.5-10 ml/L.

In some embodiments the penetrant comprises an alkoxylated alcohol, a saponin, and/or an organosilicone compound.

In some embodiments the alkoxylated alcohol is an alcohol ethoxylate. In some embodiments the alcohol ethoxylate is ethoxylated soybean oil.

In some embodiments the organosilicone compound is an organomodified polydimethyl siloxane or an organomodified trisiloxane.

In some embodiments the concentration of organomodified polydimethyl siloxane penetrant is about 0.5-20 ml/L. In some embodiments the concentration of organomodified polydimethyl siloxane penetrant is about 2-10 ml/L. In some embodiments the concentration of organomodified polydimethyl siloxane penetrant is about 5 ml/L. In some embodiments, the organomodified polydimethyl siloxane penetrant comprises about 600-1200 g organomodified polydimethyl siloxane per litre of penetrant.

In some embodiments the weight ratio of the artificial sweetener or sugar alcohol or an agriculturally acceptable salt thereof to the penetrant is about 1-150:1. In some embodiments the weight ratio of the artificial sweetener or sugar alcohol or an agriculturally acceptable salt thereof to the penetrant is about 2-120:1. In some embodiments the weight ratio of the artificial sweetener or sugar alcohol or an agriculturally acceptable salt thereof to the penetrant is about 5-100:1. In some embodiments the weight ratio of the artificial sweetener or sugar alcohol or an agriculturally acceptable salt thereof to the penetrant is about 10-80:1.

In some embodiments the composition of the invention comprises water.

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

As used herein the term “and/or” means “and” or “or”, or both.

As used herein “(s)” following a noun means the plural and/or singular forms of the noun.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

The disclosure consists in the foregoing and also envisages constructions of which the following gives examples only. Features disclosed herein may be combined into new embodiments of compatible components addressing the same or related inventive concepts.

### 4. BRIEF DESCRIPTION OF THE FIGURES

The invention is described with reference to the Figures in which:

FIGS. 1A and 1B are photographs showing ragwort (not flowering), before and after application of the composition of the invention, as described in Example 5.

FIGS. 2A and 2B are photographs showing thistle, before and after application of the composition of the invention, as described in Example 5.

FIGS. 3A and 3B are photographs showing ragwort (flowering), before and after application of the composition of the invention, as described in Example 5.

FIGS. 4A and 4B are photographs showing gorse, before and after application of the composition of the invention, as described in Example 5.

FIGS. 5A and 5B are photographs showing dandelion, before and after application of the composition of the invention, as described in Example 5.

FIGS. 6A and 6B are photographs showing ragwort (not flowering, before and after application of the composition of the invention, as described in Example 5.

FIGS. 7A and 7B are photographs showing gorse and amanita mushroom, before and after application of the composition of the invention, as described in Example 5.

FIGS. 8A and 8B are photographs showing gorse, before and after application of the composition of the invention, as described in Example 5.

FIG. 9 is a graph showing the survival (%) of tillage radish in response to the dose concentration (ml a.i. L⁻¹) as described in Example 10.

### 5. DETAILED DESCRIPTION OF THE INVENTION

The invention provides a contact means to control unwanted plant growth. As it works by contact, it can be used to kill, control, reduce or slow the growth of specific plants even when they are among wanted plants. Alternatively, the invention can be used to control parts of a plant without damaging the remainder, for example, desuckering grape vines, removal of shoots from bulbs or tubers and/or “soft pruning” (for example for use in the growing of cotton plants to cause the leaves or foliage to drop from the plant). It is believed the invention has little or no translocation so can be used close to non-target vegetation.

The invention relates to a method of eliminating or reducing undesired plant growth, the method comprising applying a liquid composition comprising at least one artificial sweetener or sugar alcohol or an agriculturally acceptable salt thereof and a penetrant to the undesired plant growth. Preferably an effective amount of the composition is applied to the undesired plant growth. In one embodiment the method results in a reduction of the biomass of the plant of at least 20, 30, 40, 50, 60, 70, 80, 90, 95 or 100% within 30 days. In one embodiment the method results in a reduction of the biomass of the plant of at least 20, 30, 40, 50, 60, 70, 80, 90, 95 or 100% within 7 days.

The invention further or alternatively relates to a composition for eliminating or reducing undesired plant growth comprising a liquid carrier, at least one artificial sweetener or sugar alcohol or an agriculturally acceptable salt thereof, and a penetrant.

The invention further or alternatively relates to an herbicidal composition comprising a liquid carrier, at least one artificial sweetener or sugar alcohol or an agriculturally acceptable salt thereof, and a penetrant.

The invention further or alternatively relates to a method of making a composition for eliminating or reducing undesired plant growth or an herbicidal composition, the method comprising adding at least one artificial sweetener or sugar alcohol or an agriculturally acceptable salt thereof, and a penetrant to a liquid carrier.

The invention may optionally be used in combination with other herbicides and/or other agricultural agents. An example of a herbicide is glyphosate. Other agricultural agents include, but are not limited to, a fungicide, an insecticide, a miticide, a nematicide, a soil insect pesticide, an antivirus agent, an attractant, and a plant growth regulating agent. The compositions of the invention may contain a further herbicide and/or other agricultural agent or the further herbicide and/or other agricultural agent may be applied separately. The compositions of the invention may be provided in a kit with the further herbicide and/or other agricultural agent to be combined prior to use or to be applied separately.

Further, various additives which are commonly used, such as a filler, a carrier, a thickener, a binder, a stabilizer, an anti-foaming agent, an anti-settling agent, an anti-freezing agent, a dispersion stabilizer, a preservative, colourant, an anti-mould agent, may also be used in the composition.

4.1 Artificial Sweetener and/or Sugar Alcohol

The compositions of the invention comprise at least one artificial sweetener or sugar alcohol or an agriculturally acceptable salt thereof (i.e. an agriculturally acceptable salt of the artificial sweetener or the sugar alcohol).

The salt of the artificial sweetener or the sugar alcohol may be any agriculturally acceptable salt, for example, an alkali metal salt such as a sodium salt or a potassium salt; an alkaline earth metal salt such as a magnesium salt or a calcium salt; an amine salt such as a dimethylamine or triethylamine salt or an ammonium salt; an inorganic acid salt such as a hydrochloride, a perchlorate, a sulfate or a nitrate; or an organic acid salt such as an acetate or a methanesulfonate.

The artificial sweetener or the sugar alcohol artificial sweetener or the sugar alcohol, or agriculturally acceptable salt thereof, may also be in the form of a hydrate.

The artificial sweetener or sugar alcohol or agriculturally acceptable salt thereof is preferably a hydrate or capable of forming a hydrate.

Examples of artificial sweeteners or agriculturally acceptable salts thereof include saccharin, aspartame, sucralose, acesulfame K, stevia or Lugduname.

The structure of saccharin is shown below:

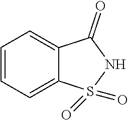 [SMILES: O=C1NS(=O)(=O)c2ccccc21]

but the agriculturally acceptable salt is preferably used in the compositions of the invention, due to its solubility. If saccharin is to be used, the concentration of penetrant may need to be increased, to aid solubility.

Preferably either the sodium or calcium salt is used, preferably the sodium salt.

A method for the synthesis of saccharine is known as the Maumee process, but other options are available.

Examples of sugar alcohols or an agriculturally acceptable salt thereof include xylitol, sorbitol, erythritol.

Preferably saccharin, preferably saccharine salt, preferably saccharine alkali metal salt, is used in the compositions as it has been found to give superior results to other artificial sweetener or sugar alcohols.

Preferably the concentration of artificial sweetener or sugar alcohol or agriculturally acceptable salt thereof in the composition is an effective amount. Preferably the concentration of artificial sweetener or sugar alcohol or an agriculturally acceptable salt thereof in the composition is about 5-600 g per litre, preferably about 5-400 g per litre, preferably about 5-300 g per litre. In some embodiments the concentration of artificial sweetener or sugar alcohol or an agriculturally acceptable salt thereof in the composition is about 10-200 g per litre. In some embodiments the concentration of artificial sweetener or sugar alcohol or an agriculturally acceptable salt thereof in the composition is about 50-200 g per litre. However, the concentration will depend on the artificial sweetener or sugar alcohol use, the ease of kill of the plant, or the level of control/ or slowing of rate of growth desired.

Preferably the concentration of saccharine salt in the composition is about 5-600 g per litre, preferably about 5-300 g per litre, preferably about 10-300 g per litre, preferably about 10-200 g per litre, preferably about 50-200 g per litre.

4.2 Penetrant

The composition of the invention comprises a penetrant. A “penetrant” refers to an agent that carries or transfers a compound into the interior of a living cell and/or permits, facilitates or increases uptake of a compound into the interior of a living cell. Agricultural penetrants dissolve or penetrate the waxy surface layers of a leaf, allowing other chemicals to contact cells and to enter the spaces between them.

Many penetrants also demonstrate surfactant properties and so may also be classed as surfactants. A surfactant is an agent that modifies the surface properties of other materials it is in contact with.

Examples of surfactants include (a) wetting agents, which reduce the surface tension of a spray droplet, increasing contact between the droplet and the leaf or insect surface, and (b) stickers, which increase adhesion of a solution to a leaf or insect surface. Emulsifiers and spreaders are also types of surfactants.

In some cases, a surfactant may act as a penetrant (a surfactant penetrant), but not all surfactants enhance penetration.

Surfactant penetrants may be non-ionic, anionic or cationic, depending on the ionic charge carried by the compound(s) making up the penetrant.

In one embodiment the penetrant for use in the composition of the invention is a non-ionic, surfactant penetrant.

Commercially available penetrants are generally compositions comprising one or more penetrant compounds in a suitable solvent. The penetrant may also comprise additional agents such as non-penetrant surfactants.

In some embodiments, the penetrant is provided in a ready to use formulation comprising one or more penetrant compounds. Preferably the concentration of penetrant compounds in the ready to use formulation is about 0.1-50% by weight, about 1-50% by weight, about 1-30% by weight, about 1-20% by weight or about 1-10% by weight.

In one embodiment the non-ionic surfactant penetrant comprises one or more organosilicone compounds, one or more complex alcohols and/or one or more saponins.

Organosilicone compounds include (but are not limited to) organomodified polydimethyl siloxane and organomodified trisiloxane.

Commercially available organosilicone penetrants include but are not limited to:
Yates Pulse®—an organomodified polydimethyl siloxane;
Ecospread®—a BioGro® certified non-ionic surfactant from the organomodified trisiloxanes chemical class;
Silwet 625®—a trisiloxane alkoxylate based wetting agent; and
Apparent Devour 1020 Penetrant®, containing 1020 g/L polyether modified polysiloxane.

A wide range of complex alcohols have also been used as penetrants including alkoxylated alcohols (alcohol alkoxylates); alkylaryl ethoxylates, for example nonylphenol ethoxylate and octylphenol ethoxylate; polyalkoxytriglycerides, for example ethoxylated soybean oil; alkoxylated fatty alcohols, for example fatty acid ethoxylates; and alkoxylated fatty amines, for example, fatty amine ethoxylates.

Commercially available complex alcohol penetrants include but are not limited to:
Agnique® SBO 10—an ethoxylated soybean oil adjuvant;
Oroboost® from Oro Agri International Ltd, which contains an alcohol ethoxylate and cold pressed orange oil;
GlyAssist 1040® surfactant, containing octyl phenol ethyoxylate and polyethylene glycol octylphenyl ether;
Apparent Wetter 1000 ®, containing non-ionic alcohol alkoxylates;
Buff It®, containing non-ionic fatty acid ethoxylates and buffering agents;
Chemwet 1000®, containing alcohol alkoxylate;
Deluge 1000® Wetting Agent, containing non-ionic fatty acid ethoxylates;
PCT Reactor Wetter 600 Surfactant®, containing nonyl phenol ethylene oxide condensate (600 g/L);
SprayPro 780® Acidifying Surfactant Compatibility Agent, containing alkylaryl polyoxyethylene glycol phosphate ester (780 g/L), propylene glycol (>100 g/L) and phosphoric acid (10-50 g/L).

Saponins are glycosides found in various plant species that have been found to have surfactant and penetrant properties.

Other penetrants include:
Protec Plus®, a blend of esterified canola oil and non-ionic surfactants (alcohol ethoxylate);
In-bound Spray Adjuvant®, containing >60% paraffinic petroleum oil and non-ionic surfactants;
Apparent Buffer 700 Surfactant®, containing soyal phospholipids (350 g/L), propionic acid (350 g/L), and surfactant;
Nexus Spray Adjuvant®, containing canola oil and non-ionic surfactants; and
Trump® Spray Oil, containing paraffinic petroleum oil (>90%) and non-ionic surfactants.

In one embodiment the concentration of penetrant in the composition of the invention is about 0.5-20 ml/L, about 0.5-15 ml/L, or about 0.5-10 ml/L. In another embodiment the concentration of penetrant in the composition of the invention is about 1-20 ml/L, about 1-15 ml/L, about 1-10 ml/L.

In some embodiments the organosilicone compound is an organomodified polydimethyl siloxane or an organomodified trisiloxane. In some embodiments the penetrant comprises at least 600, 700, 800, 900 or 1000 g/L organosilicone compound.

Preferably the concentration of organomodified polydimethyl siloxane penetrant in the composition of the invention is about 1-20 ml/L, about 2-10 ml/L, or about 5 ml/L.

Preferably the weight ratio of the artificial sweetener or sugar alcohol or an agriculturally acceptable salt thereof to the penetrant is about 1-150:1, about 2-120:1, about 5-100:1 or about 10-80:1.

In one embodiment the invention provides a herbicidal composition comprising saccharine or an agriculturally acceptable salt thereof, and an organosilicone penetrant in a liquid carrier (preferably water), wherein the contraction of saccharine is about 50-250 g/L and the concentration of organosilicone penetrant is about 0.5-10 ml/L, wherein the organosilicon penetrant comprises about 600 to about 1200 g/L organosilcone compounds.

4.3 Liquid Carrier

The preferred liquid carrier for the compositions of the invention is water, as it is environmentally sound and cost effective. However, one or more other liquid carrier(s) may be used as an alternative or in addition to water, for example alcohols, alkanes, alkenes, ketones (for example acetone), aromatics, DMSO, DMF, acetates, amines, amides, pyrrolidones, oils (for example vegetable oils or mineral oils).

If desired or required surfactants, cosolvents or mixtures of solvents can optionally be used to increase the solubility of the artificial sweetener or sugar alcohol in the liquid carrier. An example of a suitable surfactant is a detergent, for example a commercial cleaning detergent.

Reference to the liquid composition should also be taken to mean a viscous liquid or paste.

The composition of the invention may also include other agriculturally acceptable excipients such as, but no limited to, humectants, compatibility agents, defoamers, drift control agents, deposition agents, water conditioners, acidifiers, buffers and colourants.

4.4 Method of Application

The compositions of the invention are preferably applied to a portion of the undesired plant growth above ground. Various mean of application can be used, such as contacting, wetting, dousing, drenching, soaking, dipping, painting or spraying. Apparatus such as a boom sprayer, mister, blanket wiper or rope wick applicator may be used.

Preferably the composition is sprayed into the undesired plant matter, preferably is such a manner to thoroughly coat the target material. Alternatively, the composition may be painted, for example onto older undesired plant growth, such as a stump. In such a case, the composition preferably has a thicker viscosity, to aid in painting the desired area.

The composition can be applied a single time to the undesired plant growth or it may be desirable for some undesired plant growth to repeat the application a period of time after the first application, for example about a week, 2 weeks, 3 weeks, a month later, once or more further times.

Where, in the foregoing description reference has been made to integers or components having known equivalents thereof, those integers are herein incorporated as if individually set forth. Any of the aforementioned features or embodiments or aspects may be combined with one or more of the other features or embodiments or aspects as described herein.

### 5. EXAMPLES

### Example 1

### Use as Desiccant

A composition comprising 1 L Water, 100 g saccharine sodium hydrate (C₇H₄NNaO₃S·H₂O), CAS No. 82385-42-0, Pharm. Grade 99-101%), and 5 ml Yates Pulse® composition was sprayed on Onion Weed (Allium triquetrum). The composition was applied to the green stems, foliage and/or flowers during the summer (growth) season.

After 5 days the foliage withered and turned yellow. Over time the stems changed colour from green to brown and began to collapse.

Within 30 days the stems completely collapsed and perished. While inspecting the stems, white bulbs were seen ‘poking’ up above the soil. These were the Onion Weed bulbs, and they had separated from the stem and roots, leaving them “untethered” and visible at the top of the soil. This indicates the invention may be used as a desiccant for use in pre-harvesting of tubular/bulbous flowering crops such as potatoes, onions, garlic, leeks etc. The invention enhances the process by gently separating top foliage and roots beneath from the bulb. Current methods include chemical, mechanical and a combination of both.

### Example 2

### Use of Artificial Sweeteners and Sugar Alcohols as Herbicides

Compositions comprising water with saccharine sodium hydrate (C₇H₄NNaO₃S·H₂O, CAS No. 82385-42-0, Pharm. Grade 99-101%) and Pulse® penetrant were applied to various species of plant to demonstrate the broad herbicidal properties of the invention. The results are shown in Table 2.

TABLE 2

| Treatment | Plant | Results |
|---|---|---|
| 1 L Water, | Arum | Within 6 days - shrivelled and brown |
| 100 g saccharine sodium hydrate | italicum | leaves |
| 5 ml Yates Pulse ®. | | Within 6 weeks - only small amount of |
| Spayed | | plant remaining |
| | | Within 2.5 months - no plant remaining |
| 1 L Water, 100 g saccharine | Agapanthus | Within 20 days majority of plant leaves |
| sodium hydrate | | browned - some green leaves remaining |
| 5 ml Yates Pulse ®. | | Within 8 days of 2nd treatment - all |
| Spayed | | leaves wilted |
| Treatment repeated on day 20. | | Within 11 days of 2nd treatment - root |
| | | system damaged |
| | | Within 3 weeks of 2nd treatment - no |
| | | plant remaining |
| 5 L Water, | Ulex | Within 5 days - leaves browned |
| 500 g saccharine sodium hydrate | europaeus | Within 24 days of 2nd treatment - |
| 20 ml Yates Pulse ®. | (gorse) | entirely browned plant and dieback. |
| Spayed | | |
| Treatment repeated on day 46. | | |
| 1 L Water, 100 g saccharine | Poa | Within 4 weeks - leaves mostly browned |
| sodium hydrate, 5 ml Yates | labillardiere | Within 16 weeks entirely brown leaves |
| Pulse ® | (tussock | and smaller root ball |
| Sprayed | grass) | Within 39 weeks - only a portion of |
| | | dried root ball remaining. |

Compositions comprising sugar alcohols erythritol and xylitol were tried on small domestic weeds in New Zealand (grassy and leafy). The results are shown in Table 3. Both erythritol and xylitol compositions showed herbicidal properties but were not as effective as the saccharine compositions. The saccharine compositions showed particularly good herbicidal properties, compared to the sugar alcohols, erythritol and xylitol.

TABLE 3

| Treatment | Results |
|---|---|
| 50 g Erythritol, 500 ml water, | Signs of die-back on tips edges of |
| 2.5 ml Yates Pulse ™. | herbaceous foliage |
| Sprayed | Slightly more signs of control with |
| | grasses |
| 100 g Xylitol, 1 L Water, 5 ml | Better effect than the Erythritol |
| Yates Pulse ™. | Soft, small, fragile ground cover |
| Sprayed | species appears to have been all |
| | controlled |
| | Other species of plants have shown |
| | lesser effects |
| 40 g Stevia, 400 ml water, with | Some effect on plantain plant. |
| surfactant (dishwashing liquid), | |
| 5 ml Yates Pulse ™. | |
| Sprayed | |

### Example 4

### Use of Saccharine Sodium Hydrate as a Herbicide Against Dandelion Plants

Compositions comprising water, saccharine sodium hydrate (at various doses) (C₇H₄NNaO₃S·H₂O, CAS No. 82385-42-0, pharm. grade) and penetrant (Yates Pulse®) were applied to dandelions. The results are shown in Table 4.

TABLE 4

| Treatment | Results |
|---|---|
| 1 L Water with | Small amount of damage to plant |
| 5 ml Yates Pulse ® | |
| (Control composition) | |
| 10 g saccharine sodium hydrate, 1 L | Damage to plant, but plant |
| Water, with 5 ml Yates Pulse ® | recovers |
| 30 g saccharine sodium hydrate, 1 L | Plant killed (but at slower rate |
| Water, with 5 ml Yates Pulse ® | than 100 g saccharine sodium |
| | hydrate) |
| 100 g saccharine sodium hydrate, 1 L | Plant killed (but at slower rate |
| Water, with 5 ml Yates Pulse ® | than 300 g saccharine sodium |
| | hydrate) |
| 300 g saccharine sodium hydrate, 1 L | Immediate kill of plant. |
| Water, with 5 ml Yates Pulse ® | Immediately visible results. |

### Example 5

### Use of Sodium Saccharine as a Herbicide Against a Variety of Plant Species

A composition comprising 1 L Water, 100 g saccharine sodium (C₇H₄NNaO₃S), CAS 128-44-9 and 5 ml Yates Pulse™ was sprayed onto the plants. The composition was applied to the green stems, foliage and/or flowers in late summer in Dunedin, New Zealand.

A: Ragwort (Jacobaea vulgaris formerly Senecio jacobaea): Some in the vegetative phase (not flowering) some in reproductive phase (flowering).

B: Gorse (Ulex europaeus): Young soft seedlings to 600 mm high

C: Flowering currant (Ribes sanguineum): Single shrub 500 mm high

D: Dandelion, Cat's ear (Hypochaeris radicata) Single rosette, ground hugging, not flowering

E: Foxglove (Digitalis purpurea) Single rosette, not flowering

Results

Wilting and necrosis (browning) was observed 4 hours after application on all species except Flowering currant and gorse which only showed tip curling/wilting. After 30 hours, complete wilting and necrosis of all species was seen except Flowering currant which showed a patchy necrosis at this stage. At 56 hours Flowering currant wilting and necrosis was complete.

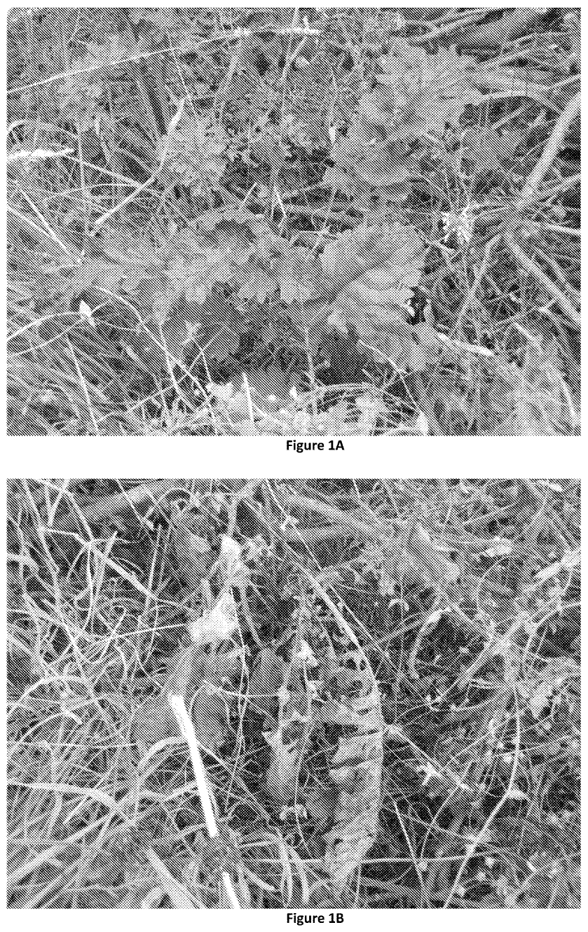

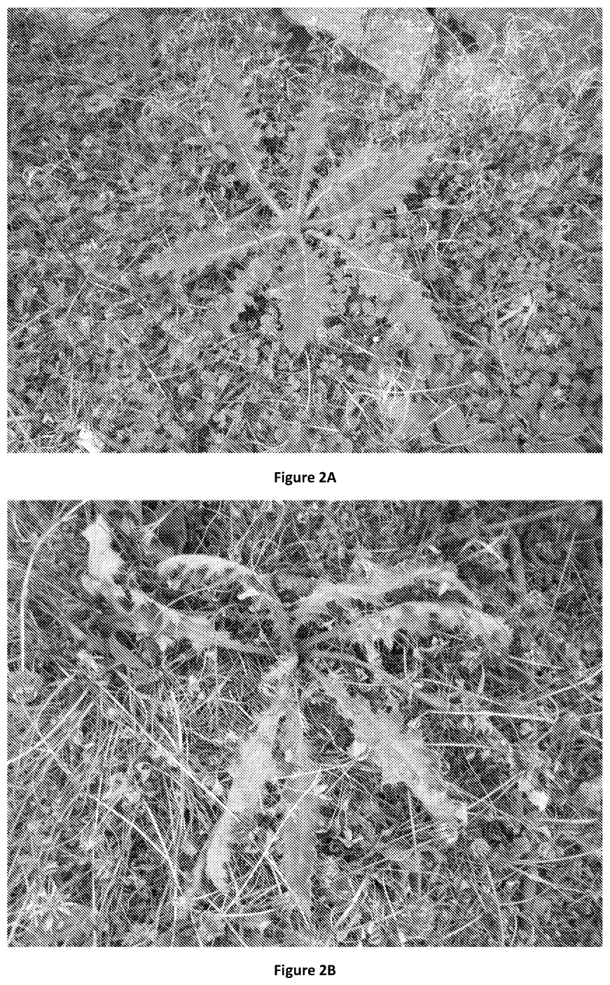

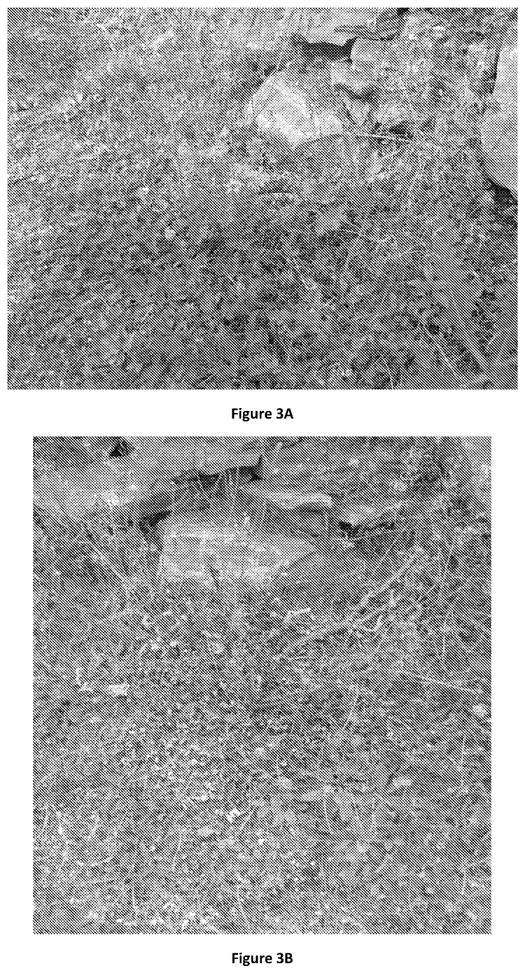

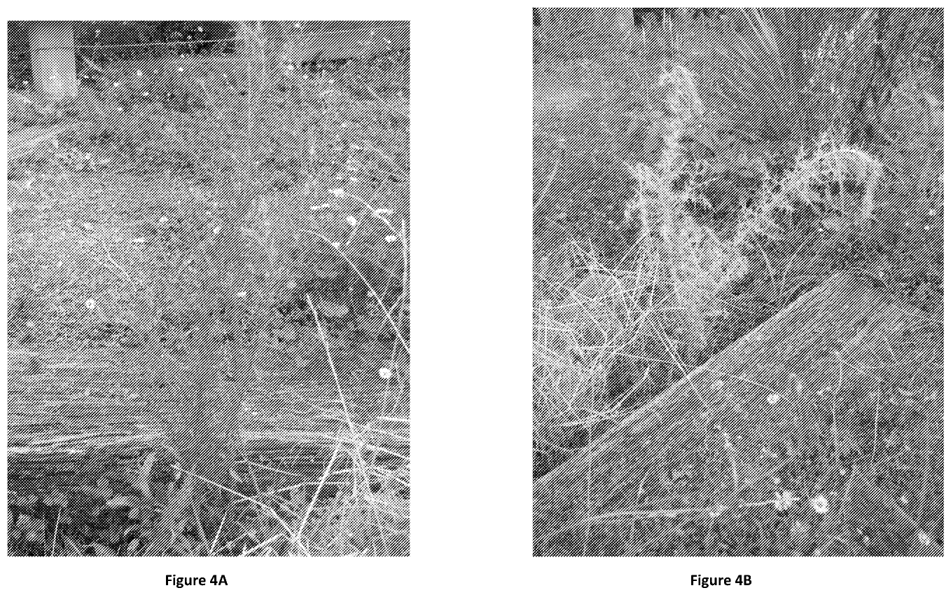

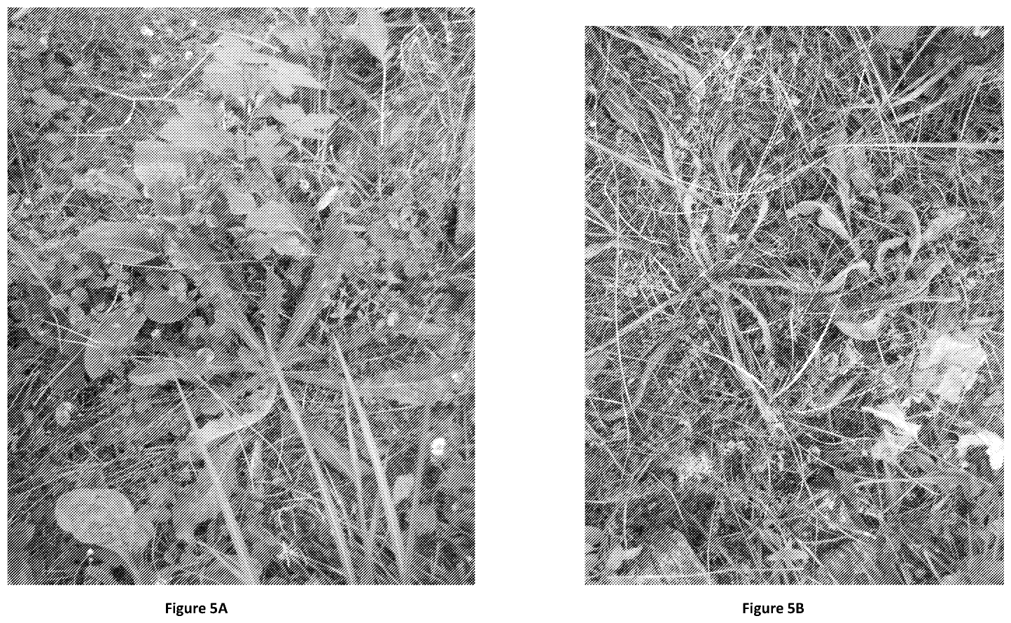

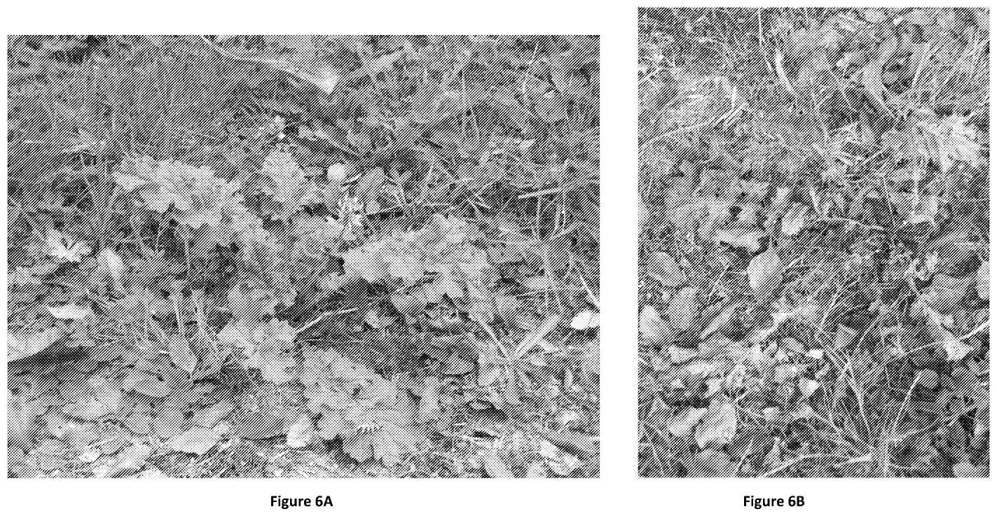

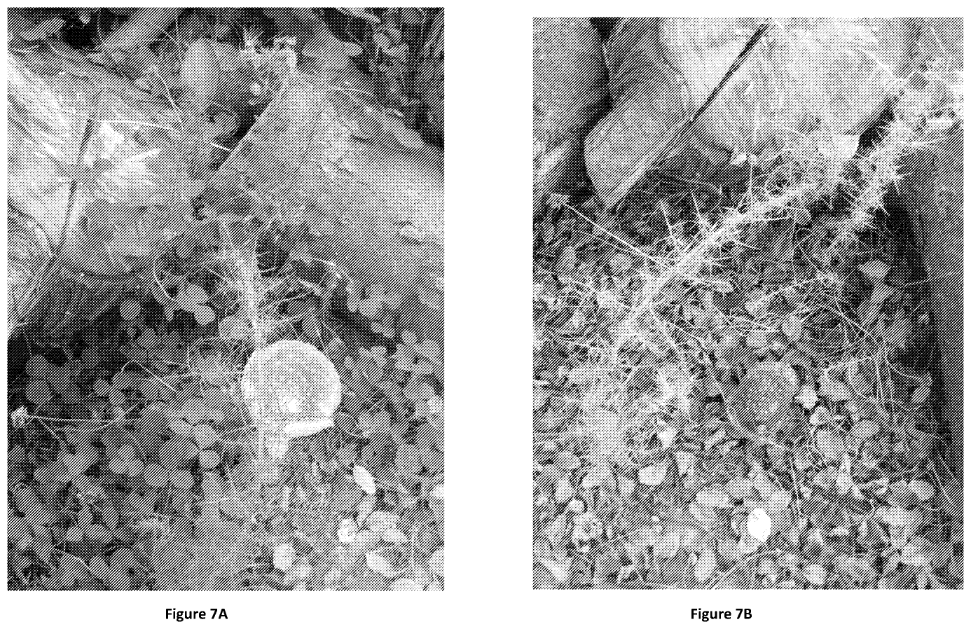

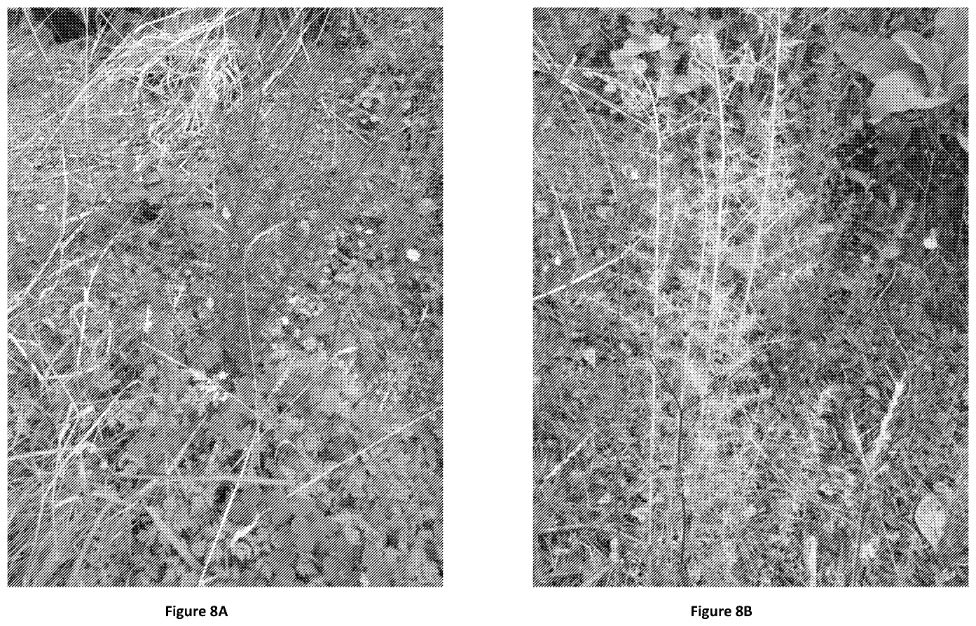

The effect on the gorse seedlings was quite remarkable. Application of glyphosate and Pulse® sometimes gives a nodding (wilting) of the young tips after a few hours to a few days, but often wilting and necrosis is not convincing until 10 days after application. Application of the composition of the invention caused a distinct bleaching of the young gorse plants rather than the browning that occurs on application of glyphosate. The results are shown in FIGS. 1-8.

### Example 6

### Use of Sodium Saccharine and a Variety of Penetrants

Compositions comprising water, saccharine sodium (C₇H₄NNaO₃S, food grade, CAS No. 128-44-9) and penetrant were applied to a variety of plant species by spraying onto the foliage.

The results are shown in Table 5.

TABLE 5

| Treatment | Results |
|---|---|
| 50 g sodium saccharin, | Browning, wilting and decrease in mass, plant |
| 2 ml Apparent Wetter 1000 ® and | dead after 12 days |
| 248 ml water | |
| 50 g sodium saccharin, | Fast reaction, wilting, change of colour after |
| 2 ml Apparent GlyAssist 1040^{T} ® and | one day. Plantains completely dead after 12 |
| 248 ml water | days |
| 50 g sodium saccharin, | All over wilting change in colour and decrease |
| 2 ml Apparent Buffer 700 ® and | in mass |
| 248 ml water | |
| 50 g sodium saccharin, | Fast reaction on plantains - change of colour, |
| 1-2 ml Buff It ® and 248 ml water | wilting. Grasses reacted by slower |
| 50 g sodium saccharin, | Fast reaction - change of colour wilting, |
| 1-2 ml Chemwet ® and 248 ml water | reduction in biomass |
| 50 g sodium saccharin, | Immediate wilting, change of colour, decrease |
| 2 ml Deluge 1000 ® and 248 ml water | in biomass |
| 50 g sodium saccharin, | Fast reaction, complete wilting and change of |
| 2 ml Devour 1020 ® and 248 ml water | colour, decrease in biomass |
| 50 g sodium saccharin and | Fast reaction, change of colour and wilting |
| 2 ml In-bound ® and 248 ml water | |
| 50 g sodium saccharin and | Immediate reaction, change of colour and |
| 2 ml Nexus ® and 248 ml water | drying out |
| 50 g sodium saccharin and | Decrease in mass and slight colour change in |
| 2 ml PCT Reactor Wetter 600 | grass, complete death of woody species |
| Surfactant ® and 248 ml water | |
| 50 g sodium saccharin and | Fast reaction, change of colour, wilting and |
| 2 ml Protec Plus ® and 248 ml water | mass decrease across all species treated |
| 50 g sodium saccharin and | Wilting, change of colour, reduction in biomass |
| 2 ml Spray Pro ® and 248 ml water | observed, particularly in plantains |
| 50 g sodium saccharin and | Immediate reaction, wilting, change of colour, |
| 25 ml Trump Spray Oil ® and 248 ml | decrease in biomass |
| water | |
| 2 ml Devour 1020 ® and 248 ml water | No effects visible after 9 days, no change of |
| (control) | colour, wilting, loss of biomass |
| 50 g sodium saccharin and | No effects visible after 6 days, no change of |
| in 250 ml water (control) | colour, wilting, loss of biomass |
| 50 g sodium saccharin and 2 ml canola | No effects visible after 6 days, no change of |
| oil in 248 ml water | colour, wilting, loss of biomass |
| Water only (control) | No effects visible after 6 days, no change of |
| | colour, wilting, loss of biomass |

While all of the compositions of the invention were effective herbicides, the compositions comprising an organosilicon penetrant were found to be the most effective, acting quickly and killing the plants completely.

### Example 7

### Use of Calcium Saccharine

A composition comprising 20 g calcium saccharine (CAS No. 6381-91-5), 1-2 ml penetrant (Devour 1020™) and 98 ml water was sprayed on the foliage of a variety of plants. There was an immediate reaction, with the plants changing colour and wilting.

### Example 8

### Use of Sodium Saccharine Dihydrate

A composition comprising 50 g sodium saccharine dihydrate (CAS No. 6155-57-3), 1-2 ml penetrant (Devour 1020™) and 268 ml water was sprayed on the foliage of a variety of plants. There was an immediate reaction, with the plants changing colour and wilting.

### Example 9

### Use of Sodium Saccharine Composition

A composition comprising 20 g sodium saccharine (CAS No. 6381-91-5), 0.5 ml penetrant (Devour 1020™) and 1 L water was sprayed on the foliage of a variety of plants.
Trial date: 15 Mar.-15 Apr. 2021
Trial location: Lansdowne farm, University of Sydney, Camden.
Procedures: A range of weeds commonly found at Lansdowne farm were selected for spot spray testing using a standard knapsack sprayer with a flat fan spray nozzle. Weeds included mallow, sowthistle, pigweed, Shephard's purse, swine watercress, crowsfoot grass, carrot weed, cape dandelion, fat hen, barnyard grass, medic weed and fleabane. All selected weeds were tagged with red pin flags. Weeds were sprayed until they were completely saturated, and the solution just begins to drip off. Once sprayed, plants were continuously observed for the development of any symptoms.
Conditions: The composition of the invention was applied under sunny conditions at 11:00 am with a wind speed of 5 km/hr.
Results: A total of 17 weeds (both grass and broad-leaved) were selected for treatment. The foliage damage symptoms started appearing 24 hours of spray in all weeds. 15 out of 17 plants were killed with only pigweed and unidentified species 1 surviving 30 DAS (days after spray).

### Example 10

### Dose Response for Sodium Saccharine/Devour 1020 Composition

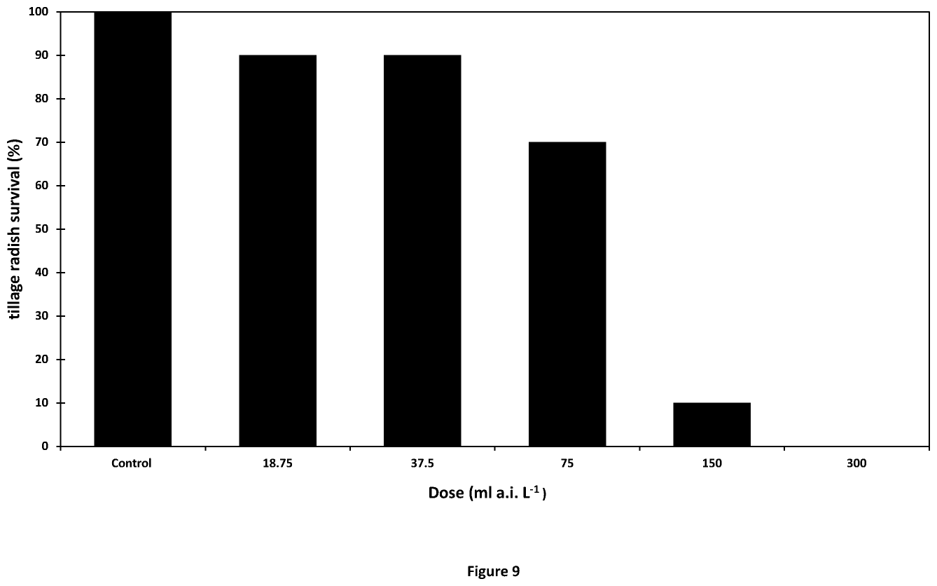

A stock solution of 200 g sodium saccharine (CAS No. 6381-91-5) and 5 ml penetrant (Devour 1020™) was made up to 1 L water then used at various concentrations, further diluted in water as set out below.
Trial date: 15 Apr.-15 May 2021
Trial location: Hoop-house facility, Lansdowne, University of Sydney, Camden.
Procedures: Representative grass (forage oats, Avena sativa) and broadleaf weed (tillage radish, Raphanus sativus) species were established in separate potting mix filled seedling containers. There were 10 replicate containers of each weed species and for each of the six herbicide treatments. When seedlings have reached the 5 to 6 true leaf stage, they will be screened with six concentrations of the candidate herbicide. A herbicide dilution series was used to examine the effects of reducing herbicide concentrations on efficacy. Each seedling was sprayed in a back, then forth manner using a flat fan nozzle. Each seedling was thoroughly covered with herbicide solution with approximately 10 ml of herbicide solution applied during the 2 second treatment period. Approximately 4 weeks after treatment plant survival was assessed. Then above-ground plant material for each surviving plant was harvested, oven-dried at 70° C. for 72 hours, and weighed for the determination of dry matter production. Survival percentages and dry matter production relative to an untreated control were calculated to determine treatment effects on plant survival and plant growth, respectively.
Conditions: The composition of the invention was applied on a clear day at 11:00 am with a wind speed of 5 km/hr.
Dose rates: 300 ml/L, 150 ml/L, 75 ml/L, 37.5 ml/L, 18.75 ml/L, 0 ml/L (Control)
Results: Tillage radish was more sensitive to the candidate herbicide compared to forage oats. The survival rate (%) of tillage radish gradually decreased with the increasing concentration of the herbicide dose (FIG. 9).

Although the present disclosure has been described in terms of certain embodiments, other embodiments apparent to those of ordinary skill in the art also are within the scope of this disclosure. Thus, various changes and modifications may be made without departing from the spirit and scope of the disclosure. For instance, various components may be repositioned as desired. Moreover, not all of the features, aspects and advantages are necessarily required to practice the present disclosure. Accordingly, the scope of the present disclosure is intended to be defined only by the claims that follow.

1. A composition for eliminating or reducing undesired plant growth comprising:
a liquid carrier, at least one artificial sweetener or sugar alcohol or an agriculturally acceptable salt thereof, and a penetrant.

2. The composition of claim 1 wherein the artificial sweetener or an agriculturally acceptable salt thereof is saccharine, aspartame, sucralose, acesulfame K, stevia or Lugduname.

3. The composition of claim 1 wherein the concentration of artificial sweetener or sugar alcohol or an agriculturally acceptable salt thereof in the composition is about 5-600 g per litre, preferably about 5-400 g per litre, preferably about 5-300 g per litre, preferably about 10-200 g per litre, preferably about 50-200 g per litre.

4. The composition of claim 1, wherein the artificial sweetener or sugar alcohol or an agriculturally acceptable salt thereof is saccharine, preferably sodium saccharine.

5. The composition of claim 1, wherein the penetrant comprises an alkoxylated alcohol, a saponin and/or an organosilicone compound.

6. The composition of claim 5 wherein the alkoxylated alcohol is an alcohol ethoxylate or ethoxylated soybean oil.

7. The composition of claim 1, wherein the concentration of penetrant in the composition is about 0.5-20 ml/L, preferably about 0.5-15 ml/L, preferably about 0.5-10 ml/L.

8. The composition of claim 7 wherein the penetrant is an organomodified polydimethyl siloxane penetrant.

9. The composition of claim 1, wherein the weight ratio of the artificial sweetener or sugar alcohol or an agriculturally acceptable salt thereof to the penetrant is about 1-150:1, preferably about 2-120:1, preferably about 5-100:1, preferably about 10-80:1.

10. The composition of claim 1, wherein the liquid carrier comprises water.

11. A method of eliminating or reducing undesired plant growth, the method comprising applying a liquid composition according to claim 1 to the undesired plant growth.

12. The method of claim 11 wherein the liquid composition is applied to the undesired plant growth by contacting, wetting, dousing, drenching, soaking, dipping, painting or spraying.

13. The method of claim 12, wherein the application of the liquid composition is repeated one or more times.

14. The method of claim 13, wherein the application is repeated within about 1 month of a first application.

15. The method of claim 12, wherein the undesired plant growth is suckers which are part of a desired plant or shoots from a desired bulb or tuber.

16. The method of claim 11, wherein application of the method results in a reduction of the biomass of the plant of at least 20, 30, 40, 50, 60, 70, 80, 90, 95 or 100% within 30 days.

17. The method of claim 11, wherein application of the method results in a reduction of the biomass of the plant of at least 20, 30, 40, 50, 60, 70, 80, 90, 95 or 100% within 7 days.
